(19) United States
(12) Patent Application Publication
(10) Pub. No.: US 2018/0132433 A1
(43) Pub. Date: May 17, 2018

(54) PLANTING SYSTEM FOR OPTIMIZATION OF PLANT GROWTH

(71) Applicants: KRISTOPHER RYAN KAMINSKI, COSTA MESA, CA (US); RYAN ERIC MARTINAGE, ORANGE, FL (US)

(72) Inventors: KRISTOPHER RYAN KAMINSKI, COSTA MESA, CA (US); RYAN ERIC MARTINAGE, ORANGE, FL (US)

(21) Appl. No.: 15/351,976

(22) Filed: Nov. 15, 2016

(51) Int. Cl. A01G 27/00; A01G 9/02

(52) U.S. Cl. CPC A01G 27/008; A01G 9/02

(57) ABSTRACT

A planting system according to the present disclosure includes a pot configured to contain a planting medium, and an irrigation ring configured to be inserted within the pot and to irrigate the planting medium. The irrigation ring is an annular body including a first planar wall defining a first set of outlet openings, a second planar wall intersecting the first planar wall at a vertex and defining a second set of outlet openings, a third set of outlet openings formed along the vertex. The size, positions, and geometry of the outlet openings are selected so that water ejected from the ring saturates the planting medium substantially evenly throughout an annular wet zone in the top surface of the planting medium, while leaving dry zones in the center and the outer perimeter of the pot.

### TECHNICAL FIELD

This disclosure relates to horticulture. More particularly, the disclosure relates to a planting system that includes features for optimizing plant growth.

### BACKGROUND

It is often advantageous to grow and cultivate plants in containers rather than directly in the ground, since containers allow greater control over the planting medium, and are less likely to be exposed to parasites and weeds. Containers also allow plants to be moved indoors during inclement weather. However, traditional planters, which typically consist of a hard-sided plastic or ceramic pot having a drainage hole or holes at the bottom, have several drawbacks. For instance, the hard-sided pot may not allow an optimal level of oxygen to reach the roots, thus lowering the growth potential of the plants. In addition, overwatering can occur due to lack of drainage if the drainage holes do not drain quickly enough Finally, the plants become root-bound very quickly with traditional planters, especially if the pots are not large enough.

Some of the problems associated with traditional planters are overcome by fabric planters having porous sides and bottoms that allow oxygen to reach, and water to drain away from, the roots of the plants. This allows the root tips to dehydrate, forcing the root tips to branch out and become more productive. However, the plants being grown in fabric planters are prone to be under-watered because of their porous fabric.

Attempts have been made to combine the features of traditional and fabric planters by providing ceramic or plastic pots with fabric liners. However, the drainage and oxygenation in most of these hybrid systems is still inadequate. Furthermore, the roots of the plants eventually grow through the fabric liners and may spiral, twist, kink, or become strangled in the bottom of the pot. Combined with water tabling, this can choke the plant when so much of the root mass is under water.

Another issue associated with planting systems is irrigation. Some planters position a reservoir of water in direct contact with the planting medium, and rely on capillary action to draw the water upwardly into the medium. A problem with this type of a system is that the lower part of the planting medium is always wet. Since the lower roots specialize in feeding, the constant excess moisture can slow growth and cause root disease. Other planters use drip systems, in which a dripper is implanted in or suspended over the planting medium. The dripper may be in the form of a ring having a number of drip holes formed along its lower surface. However, conventional drip rings do not distribute water through the planting medium in an optimum fashion.

The above problems are addressed by this disclosure as summarized below.

### SUMMARY

A planting system according to the present disclosure includes a pot configured to contain a planting medium, and an irrigation ring configured to be inserted within the pot and to irrigate the planting medium.

In one aspect of the disclosure, the irrigation ring is an annular body including a first planar wall defining a first set of outlet openings, a second planar wall intersecting the first planar wall at a vertex and defining a second set of outlet openings, and a third set of outlet openings formed along the vertex. The annular body may include upper and lower portions, where the upper portion is a cover having an inlet opening, and the lower portion includes the first and second planar walls. The outlet openings may be arranged in a pattern configured to create at least one dry zone in a planting medium in a pot containing the ring. Each of the outlet openings may be configured as a bore having a substantially triangular cross-section. The cross-section of the openings in the planar walls may be right triangles, while the cross-section of the openings in the vertex may be isosceles triangles.

The irrigation ring may also include legs coupled to the annular body. The ends of the legs may be tapered to facilitate insertion in the planting medium. The legs may also include stop flanges that limit the depth of insertion.

In another aspect of the disclosure, an irrigation ring is provided for irrigating a plant having a stem centered within a pot containing a predetermined volume of planting medium, the pot having a peripheral wall with a predetermined inner diameter. The ring has an annular body, an outlet, and a predetermined number of outlet openings. The diameter of the annular body, as well as the dimensions, geometry, number, and location of the outlet openings are selected so that water ejected from the ring saturates the planting medium substantially evenly throughout an annular wet zone in the top surface of the planting medium. The annular body may subtend an angle of less than 360 degrees and greater than 345 degrees, and the outlets may be positioned at substantially 30 degree intervals around the annular body. In addition, the outlets may be triangular in cross section and may be configured to eject pressurized water in the form of a spray.

In still another aspect of the disclosure, a planting system comprises a pot configured to contain a predetermined volume of planting medium, and an irrigation ring configured to be inserted within the pot and to irrigate the planting medium The irrigation ring includes an annular body, a first planar wall defining a first set of outlet openings, a second planar wall intersecting the first planar wall at a vertex and defining a second set of outlet openings, and a third set of outlet openings formed along the vertex. The diameter of the annular body, as well as the dimensions, geometry, number, and location of the outlet openings are selected so that water ejected from the ring saturates the planting medium substantially evenly throughout an annular wet zone in the top surface of the planting medium. The diameter of the annular body, and the dimensions, geometry, number, and location of the outlet openings may also be selected to create two dry zones including a first dry zone configured substantially as a circle having a predetermined radius and located at the center of the pot; and a second dry zone configured substantially as an annulus of predetermined width located adjacent the peripheral wall of the pot, wherein the annular wet zone is located between the two dry zones. The openings may be triangular in cross section.

### BRIEF DESCRIPTION OF THE DRAWINGS

FIG. 1 is a perspective view of a pot and base of a planting system according to the present disclosure.

FIG. 2 is longitudinal sectional view of pot of FIG. 1, with the base removed.

FIG. 3 is a longitudinal sectional view similar to FIG. 2, with a drainage grid, liner, planting medium and spray ring inserted in the pot.

FIG. 4 is a perspective view of the drainage grid shown in FIG. 3.

FIG. 5 is a top view of the drainage grid of FIG. 4.

FIG. 6 is a sectional view taken through line 6-6 of FIG. 6.

FIG. 7 is a bottom view of the drainage grid of FIG. 5.

FIG. 8 is a perspective view of a spray ring according to the present disclosure.

FIG. 9 is a bottom view of the spray ring of FIG. 8.

FIG. 10 is a sectional view taken through line 10-10 of FIG. 9.

FIG. 11 is an irrigation map showing the distribution of water in a planting system according to the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

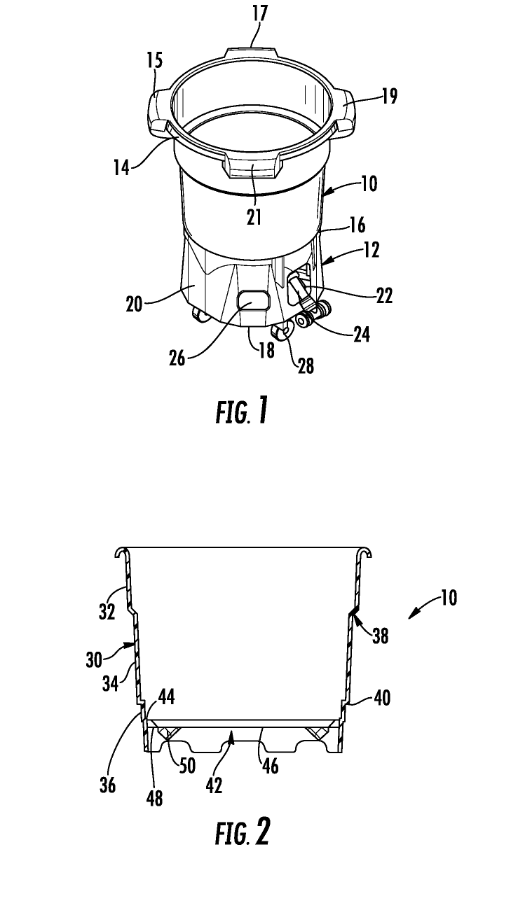

FIG. 1 shows a pot 10 and base 12 of a planting system according to the present disclosure. The pot 10 is generally cylindrical and has an outwardly extending rim 14 formed at its upper end. A set of radially extending gripping members 15, 17, 19, and 21 are provided along the rim 14. The base 12 is an annular member having open upper and lower ends 16, 18. A slightly tapered side wall 20 extends between the ends 16, 18. The side wall 20 includes large openings 22 that allow irrigation lines 24 to pass through, as well as foot holes 26 that a user can step into while pulling upward on gripping members 15, 17, 19, and 21 to separate the pot 10 from the base 12. The base 12 may also include casters 28 enabling the pot 10 and base 12 to be easily moved from one location to another. Both the pot 10 and base 12 may be made from molded thermoplastic material. For instance, the pot may be made from high density polytheleyne (HDPE), and the base 12 may be made from acrylonitrile butadiene styrene (ABS).

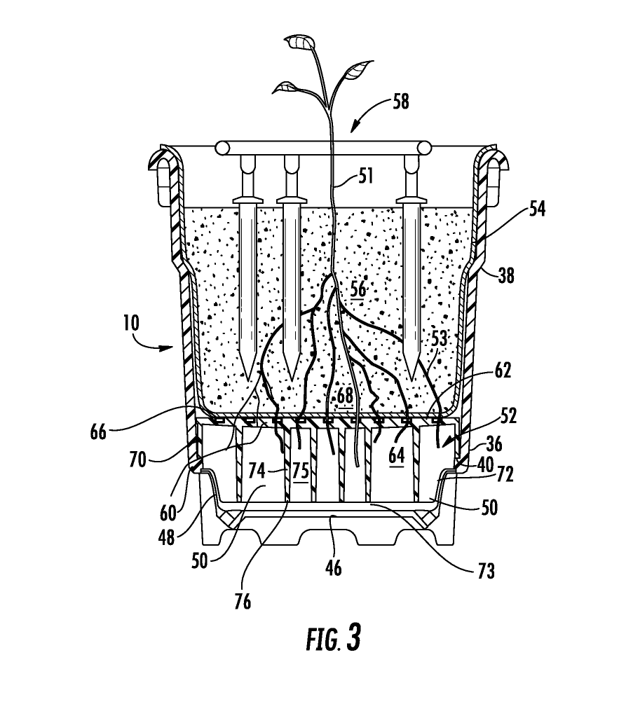

As best seen in FIG. 2, the pot 10 includes a side wall 30 having an upper side wall portion 32, a central side wall portion 34, and a lower side wall portion 36. A short transition surface 38 joins the upper side wall portion 32 to the central side wall portion 34 at an angle of about 45°, and a substantially perpendicular inner shoulder 40 joins the central side wall portion 34 to the lower side wall portion 36. The outer bottom surface of shoulder 40 abuts against the upper end 16 of the base 14 when the pot 10 is inserted in the base as shown in FIG. 1. The pot 10 also includes a floor 42 having an outer peripheral portion 44 that extends substantially perpendicularly to the lower side wall portion 36, and a sunken central portion 46 that functions as a sump. The peripheral portion 44 and sunken central portion 46, both of which are substantially planar, are joined to one another to one another by a curved transition portion 48. The transition portion 48 includes a pair of drainage openings 50 configured to connect to the irrigation lines 24 shown in FIG. 1.

FIG. 3 is a sectional view showing a top feed spray planting system according to the present disclosure, including the pot 10 in combination with a drainage grid 52, a liner 54 filled with planting medium 56, and a spray ring 58 configured to eject pressurized water into the planting medium 56. The liner 54, which is positioned above the drainage grid 52, may be a conventional liner formed from a breathable material that allows oxygen to reach the roots 53 of a plant 51 in the planting medium 56, and also allows water ejected from the spray ring 58 to drain out of the planting medium 56.

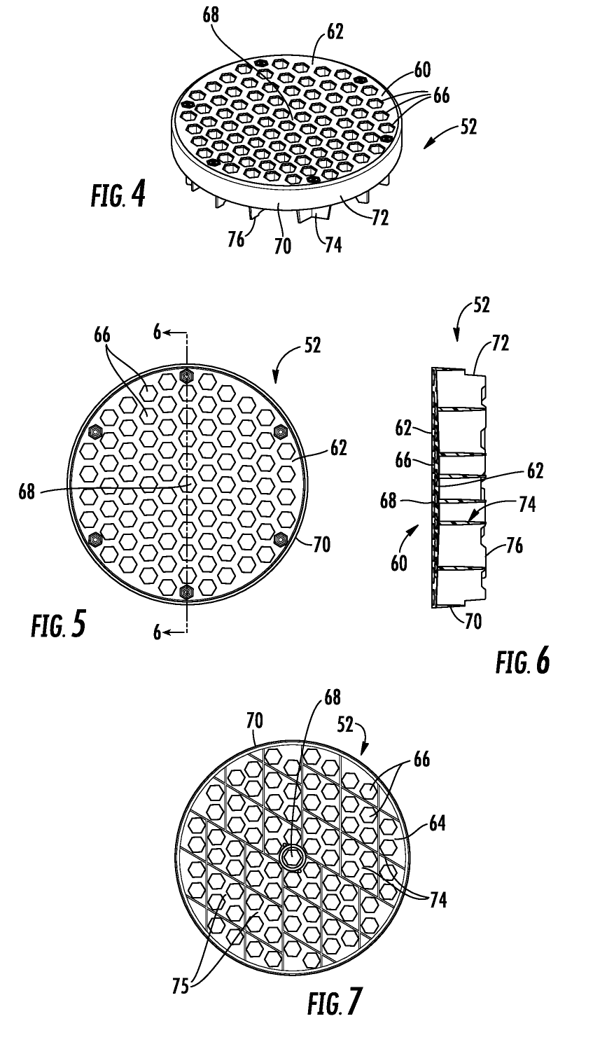

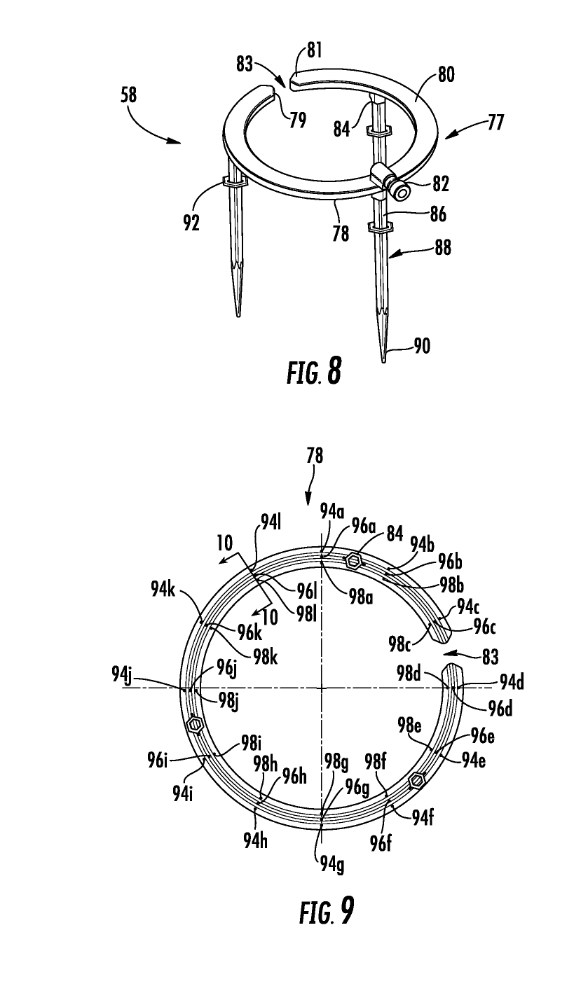

Additional views of the drainage grid 52 are shown in FIGS. 4-7. Drainage grid 52 includes a plate 60 having a top surface 62 and a bottom surface 64. A plurality of apertures 66 extend through the top and bottom surfaces 62, 64 of the plate 60. The apertures 66 are sized and configured to allow roots of a plant in the planting medium to extend through the plate 60. Although shown here to be hexagonal, the apertures 66 need not be restricted to any particular shape.

Plate 60 is slightly concave. Otherwise stated, the plate 60 slopes slightly downwardly toward the center 68 of the plate 60. In one embodiment of the invention wherein the pot is configured to contain approximately 105 liters of planting medium, the plate 60 has a diameter of about 22 inches and slopes downwardly in a continuous arc having a radius of curvature of about 116 inches. The concavity of the plate 60 directs water inwardly toward the center 68 of the plate 60, where it passes through apertures 66 and collects in the sump formed by the sunken central portion 46 of the floor of the pot 10, before finally draining out through drainage openings 50.

Plate 60 is spaced above the floor 42 of the pot 10 by a downwardly extending peripheral side wall 70 that lies flush against the central side wall portion 34 of the pot and has a bottom end 72 that abuts against the inner surface of shoulder 40 when inserted into the pot as shown in FIG. 3. The spacing between the plate 60 and the floor 42 defines a chamber 73 allowing air to circulate freely below the plate 60, providing the roots with oxygen to increase plant metabolic rates and fruit yield. The fit between the side wall 70 and central side wall portion 34 is preferably tight enough to prevent leakage around the side wall. However, in some embodiments, the fit may be somewhat loose, to allow the grid 52 to be removed and replaced.

A plurality of intersecting slats 74 are formed on the bottom surface 64 of the plate 60. Each slat 68 has a bottom end 76 that is vertically spaced from the sunken central portion 46 of the floor 42 of the pot 10. The slats 74 provide rigidity and structural support to the plate 60 and also divide the air chamber 73 beneath the plate 60 into separate compartments 75 that prevent roots that have grown through the plate 60 from spiraling. In the illustrated embodiment, the compartments 75 are diamond-shaped quadrilaterals, each of which circumscribes about four apertures 66. This allows the roots 53 to commingle, while preventing them from becoming strangled at the bottom of the pot 10.

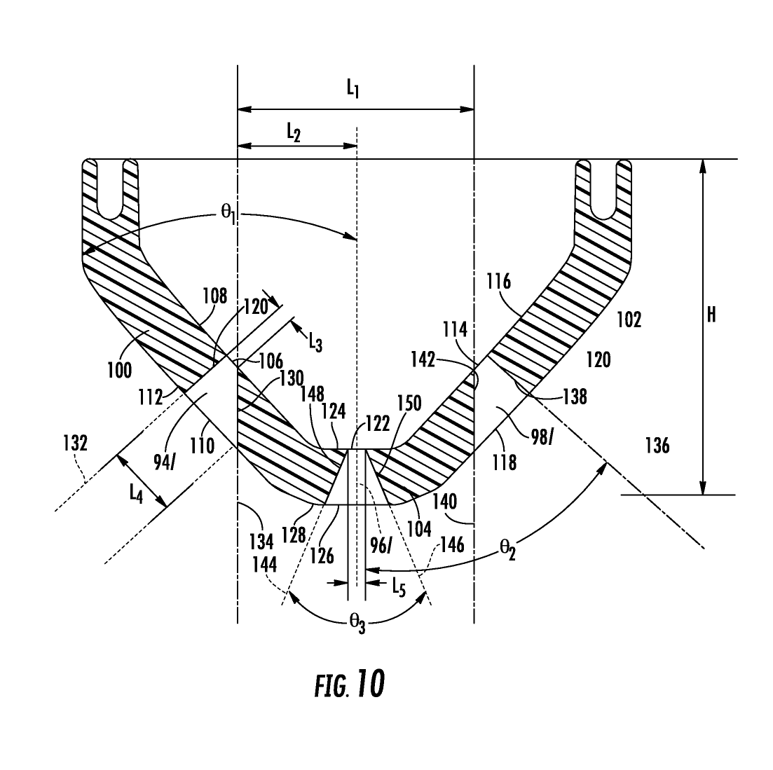

As seen in FIG. 8, spray ring 58 is an annular body 77 having a lower portion 78, a cap 80, and circumferentially spaced apart ends 79, 81 that define a gap 83 of about 5 to 10 degrees. The lower portion 78 and cap 80 may both be formed from a rugged plastic material such as ABS, and may be secured to one another by a snap fit. The cap 80 includes a fitting 82 for receiving the outlet of a hose or other conduit coupled to a source of pressurized water. The lower portion 78 includes a set of downwardly extending sockets 84 for receiving the upper ends 86 of a set of legs 88. Each leg 88 has a tapered lower end 90 allowing the legs 88 to be easily inserted into the planting medium 56, as well as an annular stop flange 92 preventing the legs 88 from being inserted beyond a predetermined depth.

The underside of lower portion 78 includes a plurality of outlet openings, as shown in FIG. 9. More specifically, the outlet openings include a set of outer outlet openings 94a-l, a set of central outlet openings 96a-l, and a set of inner outlet openings 98a-l. The outer, central outlet openings are arranged in groups. Each group includes one outer outlet opening 94, one central outlet opening 96, and one inner outlet opening 98. The three outlet openings 94, 96, 98 in each group are radially aligned with one another, and the groups are spaced a uniform angular distance from one another. In the illustrated embodiment, there are 12 groups of outlet openings, spaced at 30 degree intervals around the lower portion 78 of the spray ring 58.

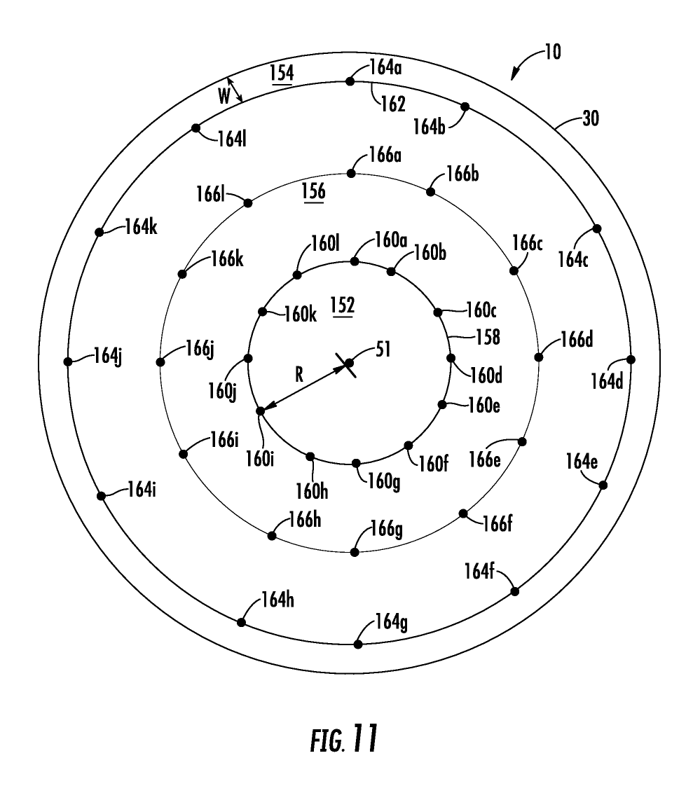

As seen in FIG. 10, the lower portion 78 of the spray ring 58 is generally V-shaped in cross-section, with an outer planar wall 100 intersecting an inner planar wall 102 at a flattened vertex 104. Outer outlet opening 941 is formed in the outer planar wall 100; central outlet opening 961 is formed in the vertex 104; and inner outlet opening 981 is formed in the inner planar wall 102. The outer outlet opening 941 is configured as a conical bore having an entrance end 106 defined in the inner surface 108 of outer planar wall 100 and an exit end 110 defined in the outer surface 112 of outer planar wall 100. Similarly, the inner outlet opening 981 is configured as a conical bore having an entrance end 114 defined in the inner surface 116 of inner planar wall 102 and an exit end 118 defined in the outer surface 120 of inner planar wall 102. The central outlet opening 961 is configured as a conical bore having an entrance end 122 formed in the inner surface 124 of the vertex 104 and end exit end 126 formed in the outer surface 128 of the vertex 104. The entrance ends 106, 114, 122 of all three outlet openings 941, 961, and 981 are smaller in cross-section than the corresponding exit ends 110, 118, 126. Central outlet opening 961 is configured as a right conical bore, and is a truncated isosceles triangle in cross-section. Outer outlet opening 941 and inner outlet opening 981 are truncated right triangles in cross-section.

The outer outlet opening 941 has an upper side wall 129 that intersects the outer surface 112 of outer planar wall 100 at a right angle and a lower side wall 130 that intersects the outer surface 112 of outer planar wall 100 at an oblique angle. Spray is emitted from the outer outlet opening 941 in the form of a cone having an outer boundary 132 that is an extension of the upper side wall 129, and an inner boundary 134 that is an extension of the lower side wall 130. Similarly, spray is emitted from the inner outlet opening 981 in the form of a cone having an outer boundary 136 that is an extension of the upper side wall 138 of the inner outlet opening 981, and an inner boundary 140 that is an extension of the lower side wall 142 of the inner outlet opening 981. Spray is emitted from the central outlet opening 961 in the form of a cone having outer and inner boundaries 144, 146 that are extensions of the symmetrical side walls 148, 150, respectively, of the central outlet opening 961.

The dimensions, positions, and geometry of the outlet openings 94a-l, 96a-l, and 98a-l, as well as the distance of the spray ring 58 above the upper surface of the planting medium 56 are selected to produce an optimum distribution of water throughout the planting medium 56. The optimum distribution pattern, shown in the irrigation map of FIG. 11, comprises a set of concentric zones including a first dry zone 152 at the center of the pot 10, a second dry zone 154 adjacent the outer side wall 30 of the pot 10, and a wet zone 156 located between the two dry zones 152, 154. The first dry zone 152 is a circular area having a radius R that is selected to keep moisture away from the stem 51 of the plant, thus reducing the possibility of stem rot. In a preferred embodiment, R=4 inches, although larger or smaller dry zones maybe preferable for different types of plants. The second dry zone is an annular area having a width W selected to prevent water from running down the sides of the pot and being wasted. In the preferred embodiment, W=1 inch.

The inner boundary 158 of the wet zone 156, which also functions as the outer boundary of the first dry zone 152, is defined by a circle connecting 12 inner spray points 160a-l. The outer boundary 162 of the wet zone 156, which also functions as the inner boundary of the second dry zone 154, is defined by a circle connecting 12 outer spray points 164a-l. A set of 12 central spray points 166a-l is located midway between the inner spray points 160a-l and the outer spray points 164a-l.

To ensure that the first and second dry zones 152, 154 stay dry, and that the wet zone 156 is substantially evenly saturated throughout, the designer must select the radius and height of the spray ring 58, as well as the geometry, dimensions, and positions of the outlet openings 94a-l, 96a-l, and 98a-l such that: 1) the outer boundary 132 of the spray emitted from each of the outer outlet openings 94a-l contacts the planting medium at a corresponding one of the outer spray points 164a-l; 2) the outer boundary 136 of the spray emitted from each of the inner outlet openings 98a-l contacts the planting medium at a corresponding one of the inner spray points 160a-l; and 3) each of the central inlet openings 96a-l is located directly below a corresponding central outlet opening 96a-l.

In one example, a spray ring having the outlet geometry illustrated in FIG. 10, with an inner diameter of 14.350 inches, an outer diameter of 16.713, and the outlet dimensions listed in Table 1 was positioned 2.37 inches above the top surface of the planting medium in a pot having a capacity of 105 liters and an inner diameter of 25.5 inches at its top end. When pressurized water was injected into the ring at a rate of 800 gallons per hour, the spray emitted from the outlets created an evenly saturated annular wet zone around the stem of a plant in the center of the pot, while leaving a first dry zone adjacent the stem and a second dry zone adjacent the outer side wall of the pot. The first dry zone was a circular area measuring about 4 inches in diameter, and the second dry zone was an annular area measuring about 1 inch in width. Rings for use with smaller or larger pots can be designed by adjusting the dimensions listed in this example proportionately to the size of the pots.

TABLE 1
Spray ring outlet dimensions for 105 L pot

| Dimension | Description | Value |
|---|---|---|
| L1 | Distance between inner and outer outlet | 0.555″ |
| | openings | |
| L2 | Distance between central outlet opening and [symbol] | 0.278″ |
| L3 | Width of upper end of inner and outer outlet | 0.039″ |
| | openings | |
| L4 | Width of lower end of inner and outer outlet | 0.17″ |
| | openings | |
| L5 | width of upper end of central outlet opening | 0.039″ |
| H | Height of lower portion of annular body | 0.736″ |
| θ1 | angle between inner/outer planar walls and [symbol] | 42° |
| θ2 | cone angle of central outlet opening | 40° |
| θ3 | angle between upper wall of inner/outer outlet | 48° |

[symbol]

indicates data missing or illegible when filed

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An irrigation ring comprising:
an annular body including
a first planar wall defining a first set of outlet openings
a second planar wall intersecting the first planar wall at a vertex and defining a second set of outlet openings;
a third set of outlet openings formed along the vertex.

2. The irrigation ring according to claim 1, wherein the annular body comprises:
a lower portion including the first and second planar walls; and
a cover secured to the lower portion, the cover including an inlet opening.

3. The irrigation ring according to claim 1, wherein each of the outlet openings is configured as a bore having a substantially triangular cross-section.

4. The irrigation ring according to claim 3, wherein:
the cross-section of each of the outlet openings in the first and second planar walls is substantially a right triangle; and
the cross-section of each of the outlet openings in the vertex is substantially an isosceles triangle.

5. The irrigation ring according to claim 3, wherein:
each of the planar walls has an inner surface and an outer surface;
each outlet opening in each planar wall has an entrance end at the inner surface of the planar wall and an exit end at the outer surface of the planar wall; and
the exit end is wider than the entrance end.

6. The irrigation ring according to claim 1, further comprising a plurality of legs coupled to the annular body, each of the legs having a tapered end configured to be inserted into a planting medium.

7. The irrigation ring according to claim 6, wherein each of the legs includes a stop flange configured to prevent the leg from being inserted beyond a predetermined depth into the planting medium.

8. The irrigation ring according to claim 1, wherein the outlet openings are arranged in a pattern configured to create at least one dry zone in a planting medium in a pot containing the ring.

9. A ring for irrigating a plant having a stem centered within a pot containing a predetermined volume of planting medium, the pot having a peripheral wall with a predetermined inner diameter; the ring comprising:
an annular body having predetermined annulus dimensions, the body defining an inlet and a predetermined number of outlet openings at predetermined outlet positions around the annular body, each of the outlet openings having predetermined outlet dimensions and a predetermined outlet geometry,
wherein the annulus dimensions, outlet dimensions, outlet positions, and outlet geometry are selected to create
a first dry zone configured substantially as a circle located at the center of the pot, the circle having a predetermined radius,
a second dry zone configured substantially as an annulus located adjacent the peripheral wall of the pot, the annulus having a predetermined width, and
an annular wet zone located between the first and second dry zones, wherein water ejected from the ring saturates the planting medium substantially evenly throughout an annular wet zone in the top surface of the planting medium.

10. The ring according to claim 9, wherein the annular body comprises:
a first planar wall defining a first set of outlet openings
a second planar wall intersecting the first planar wall at a vertex and defining a second set of outlet openings;
a third set of outlet openings formed along the vertex.

11. The irrigation ring according to claim 9, wherein each of the outlet openings is configured as a bore having a substantially triangular cross-section.

12. The irrigation ring according to claim 11, wherein:
the cross-section of each of the outlet openings in the first and second planar walls is substantially a right triangle; and
the cross-section of each of the outlet openings in the vertex is substantially an isosceles triangle.

13. The irrigation ring according to claim 11, wherein:
each of the planar walls has an inner surface and an outer surface;
each outlet opening in each planar wall has an entrance end at the inner surface of the planar wall and an exit end at the outer surface of the planar wall; and
the exit end is wider than the entrance end.

14. The irrigation ring according to claim 9, further comprising a plurality of legs coupled to the annular body and configured to support the annular body above the planting medium, wherein each of the legs comprises:
an upper end coupled to the annular body;
a tapered lower end configured to be inserted into the planting medium;
a stop flange located intermediate the upper end and the lower end and configured to rest against a top surface of the planting medium.

15. The irrigation ring according to claim 9, wherein:
the annular body subtends an angle of less than 360 degrees and greater than 345 degrees; and
the outlet openings are positioned at substantially 30 degree intervals around the annular body.

16. The irrigation ring according to claim 9, wherein the outlet openings are configured to eject water at a high pressure and in the form of a spray.

18. A planting system comprising;
a pot configured to contain a predetermined volume of planting medium, the pot having a peripheral wall with a predetermined inner diameter; and
an irrigation ring configured to be inserted within the pot and to irrigate the planting medium, the irrigation ring including
an annular body having predetermined annulus dimensions, and including
a first planar wall defining a first set of outlet openings,
a second planar wall intersecting the first planar wall at a vertex and defining a second set of outlet openings, and
a third set of outlet openings formed along the vertex,
each of the outlet openings having a predetermined outlet position, a predetermined outlet geometry, and predetermined outlet dimensions selected such that water ejected from the ring substantially evenly saturates the planting medium substantially throughout an annular wet zone in the top surface of the planting medium.

19. The planting system according to claim 18, wherein the predetermined outlet position, predetermined outlet geometry, and predetermined outlet dimensions are selected to create:
a first dry zone configured substantially as a circle located at the center of the pot, the circle having a predetermined radius; and
a second dry zone configured substantially as an annulus located adjacent the peripheral wall of the pot, the annulus having a predetermined width;
wherein the annular wet zone is located between the first and second dry zones.

20. The irrigation ring according to claim 18, wherein each of the outlet openings is configured as a bore having a substantially triangular cross-section.
